(19) United States
(12) Patent Application Publication
(10) Pub. No.: US 2008/0126831 A1
(43) Pub. Date: May 29, 2008

(54) System and Method for Caching Client Requests to an Application Server Based on the Application Server's Reliability

(76) Inventors: Audra F. Downey, Durham, NC (US); Mark E. Peters, Chapel Hill, NC (US); Balan Subramanian, Cary, NC (US); Renganathan Sundararaman, Cary, NC (US); Sundararaman Venkataraman, Cary, NC (US)

Correspondence Address: IBM CORP. (RALEIGH SOFTWARE GROUP);c/o Rudolf O Siegesmund Gordon & Rees, LLP, 2100 Ross Avenue, Suite 2800, DALLAS, TX, 75201, US

(21) Appl. No.: 11/460,289

(22) Filed: Jul. 27, 2006

(51) Int. Cl. G06F 11/07; G06F 15/16

(52) U.S. Cl. 714/4; 709/203; 714/E11.023

(57) ABSTRACT

An Intelligent Caching Tool collects reliability statistics for an application server to build a Hidden Markov Model. Using the Hidden Markov Model, the Intelligent Caching Tool calculates a reliability index for the application server. After setting a user defined reliability threshold, the Intelligent Caching Tool caches all client requests and the status of the application server's response when the reliability index is below the reliability threshold.

### FIELD OF THE INVENTION

The present invention relates generally to electrical computers and digital processing systems, and specifically to multicomputer data transferring between a client and a server based upon the application server's reliability.

### BACKGROUND OF THE INVENTION

Web applications are deployed with a tiered architecture as shown in the example of FIG. 1. Tiered Architecture 100 includes application servers shown here as servers 120, 125 and 130 and web server 115. Web server 115 (also commonly referred to as a “proxy server”) acts as an intermediary between application servers 120, 125 and 130 and Internet 110. Web server 115 connects to application servers 120, 125 and 130 via a high-speed communications link 140. Client 105 accesses web applications running on application servers 120, 125 and 130 via Internet 110 and web server 115.

The tiered architecture is transparent to the client running web applications on the application servers. From the client's perspective, web applications appear to run on the web server, not on the application server. A tiered architecture provides advantages over an architecture that allows direct access to applications from the Internet. For example, the web server can act as a security gateway to limit access to the application servers and can allocate client requests across the application servers to balance the load between each application server.

But failures can happen to the communication link between the web server and the application servers such as a power failure, network failure or shutdown of the application server. Two failure modes can affect a client accessing an application through the web server. The first failure mode occurs when the connection between web server and application server fails after data is partially read from the client. The second failure mode occurs when the connection between web server and application server fails after data is partially written to the client. In either case, the client's request and the application server's response are interrupted.

When a first application server fails while handling a client request, the pending client request should not be affected, because the pending client request should fail-over to a second server, which should respond to the request in the same manner as the first server. The fail-over procedure should be transparent to the client. Using an Autonomic manager on the web server is known in the art for performing the fail-over function. Autonomic managers cache session information for the fail-over function. The cache can contain a copy of all client requests and the application responses. When a first application server fails during a client session, the autonomic manager uses the cache to restore the session on a second server. The interrupted transmission of the request or response is repeated at the second server, which responds in the same manner as the first application server would have responded if the failure had not occurred.

Autonomic managers perform many other functions on web servers, including: assigning all client sessions to specific application servers, monitoring session and server status, collecting statistics on server performance, and load balancing sessions across all the application servers. One example of an autonomic manager that performs these functions is the Enterprise Workload Management agent (“eWLM”) from IBM.

High availability of web applications is improved by caching all requests and responses passing through the web server. Caching every client request and server response, however, consumes both persistent and volatile memory, processor time and bandwidth. One improvement known in the art is to only cache the client requests and the status of the application server's response. In this scenario, if the application server fails, the fail-over server can pick-up where the failed server left off. But caching client requests and application server response status consumes resources.

High availability and resource utilization can also be improved by caching client requests to historically unreliable application servers, but not caching client requests to historically reliable application servers. A need exists for determining the reliability of an application server, and assigning resources for caching client requests based on the reliability of the application server.

These and other objects of the invention will be apparent to those skilled in the art from the following detailed description of a preferred embodiment of the invention.

### SUMMARY OF THE INVENTION

The Intelligent Caching Tool uses a predictive model to determine which application servers are unreliable, requiring cached client requests. The Intelligent Caching Tool collects reliability statistics for the application server and builds a Hidden Markov Model using the reliability statistics. Using the Hidden Markov Model, the Intelligent Caching Tool calculates a reliability index for the application server. After setting a user defined reliability threshold, the Intelligent Caching Tool caches all client requests and the status of the application server's response when the reliability index is below the reliability threshold.

One embodiment of the Intelligent Caching Tool allocates cache space on a sliding scale based on the applications server's reliability. In this embodiment, no cache is used for highly reliable application servers. All client requests and the status of the application server's response are cached for low reliability application servers. Partially reliable application servers are allocated a variable amount of cache space based on the reliability index. A FIFO (“First In, First Out”) method is used to remove the oldest requests from a cache that has reached the allocated size limit. In all cases, once a client/server session terminates, all requests associated with the terminated session are deleted from the cache.

A special case exists for client/server sessions that involve streaming media, also known as “re-playable cache.” Once the media stream starts, the cached client requests are no longer needed, even though the client/server session remains active. The Intelligent Caching Tool identifies a “commit point” or other operational boundary after which previously cached client requests in the session may be deleted. An operational boundary may include a specific command or event, such as starting the media stream download or transferring a megabyte of data.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is an exemplary tiered architecture for web applications;

FIG. 2 is an exemplary computer network;

FIG. 3 describes programs and files in a memory on a computer;

FIG. 4 is a flowchart of a Configuration Component;

FIG. 5 is a flowchart of a HMM Analyzer;

FIG. 6 is a flowchart of a Request Caching Component; and

FIG. 7 is a flowchart of a Cache Monitoring Component.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Intelligent Caching Tool”

Additionally, the Intelligent Caching Tool is described below with reference to an exemplary network of hardware devices, as depicted in FIG. 2. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 200 has only a limited number of nodes, including workstation computer 205, workstation computer 210, server computer 215, and persistent storage 220. Network connection 225 comprises all hardware, software, and communications media necessary to enable communication between network nodes 205-220. Unless otherwise indicated in context below, all network nodes use publicly available protocols or messaging services to communicate with each other through network connection 225.

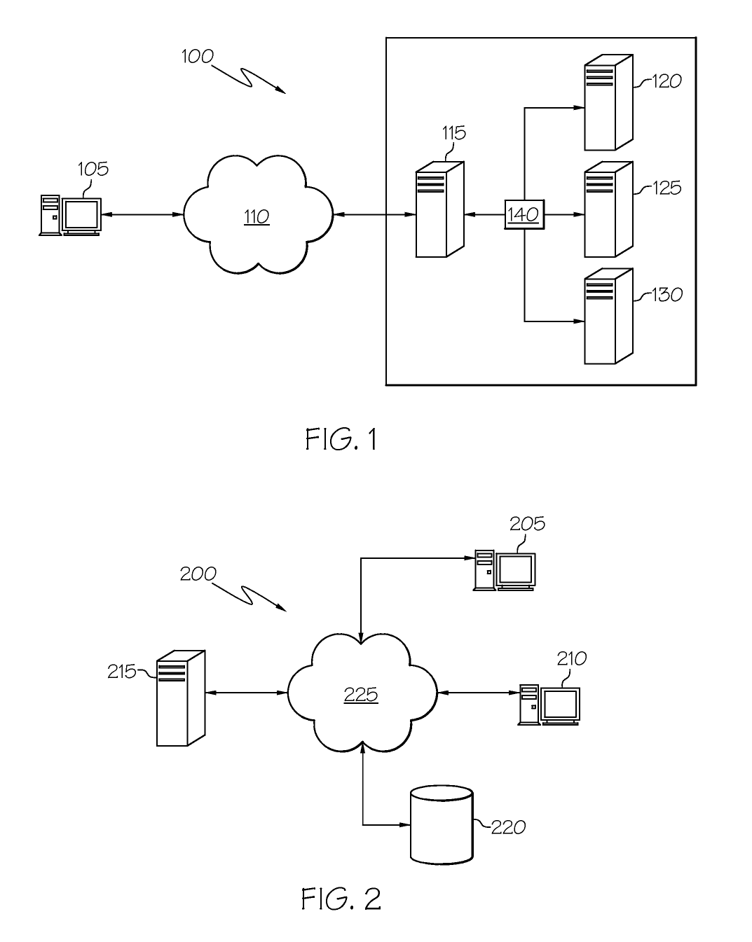

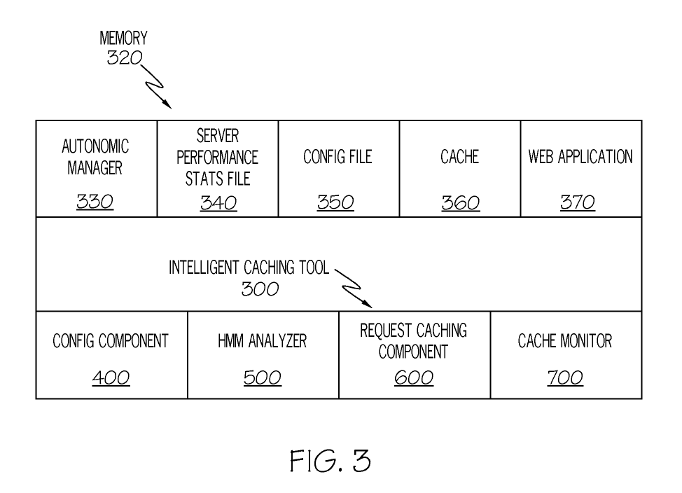

Intelligent Caching Tool 300 typically is stored in a memory, represented schematically as memory 320 in FIG. 3. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Further, Intelligent Caching Tool 300 may reside in more than one memory distributed across different computers, servers, logical partitions or other hardware devices. The elements depicted in memory 320 may be located in or distributed across separate memories in any combination, and Intelligent Caching Tool 300 may be adapted to identify, locate and access any of the elements and coordinate actions, if any, by the distributed elements. Thus, FIG. 3 is included merely as a descriptive expedient and does not necessarily reflect any particular physical embodiment of memory 320. As depicted in FIG. 3, though, memory 320 may include additional data and programs. Of particular import to Intelligent Caching Tool 300, memory 320 may include autonomic manager 330, server performance statistics file 340, configuration file 350, cache 360 and web application 370 with which Intelligent Caching Tool 300 interacts. Cache 360 can be a file saved to a disk (disk cache) or can be cache in a volatile memory. Intelligent Caching Tool 300 has four components: configuration component 400, HMM Analyzer 500, request caching component 600 and cache monitor 700. In a preferred embodiment, Intelligent Caching Tool 300 runs on web server 115 in Tiered Architecture 100 in communication with application servers 120, 125 and 130 as shown in FIG. 1. HMM Analyzer 500 uses a Hidden Markov Model to predict the reliability of application servers 120, 125 and 130 in Tiered Architecture 100.

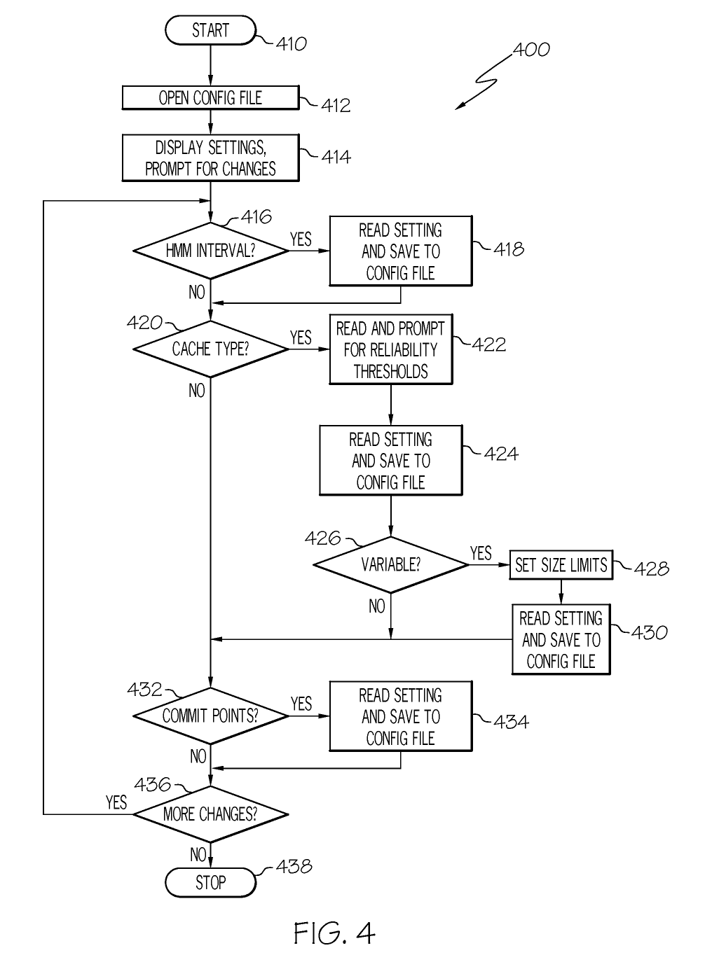

Configuration component 400 starts (410) when initiated by a systems manager or other user of a web server as seen in FIG. 4. Configuration component 400 opens configuration file 350 (412) and displays the current settings with prompts for changes (414). The prompts may include such display methods as radio buttons, scrolling lists or drop down menus. If the user chooses to change the HMM interval (416), the configuration component 400 reads the new setting and saves the setting to configuration file 350 (418). The HMM interval sets the frequency at which HMM Analyzer 500 calculates a reliability index of each application server. Alternatively, the HMM interval can be set programmatically based on specific events or commands rather than setting a regular interval. If the user chooses to change the cache type (420), configuration component 400 reads the selection and prompts the user to set reliability thresholds (422).

The user can select either simple or variable cache types. The simple cache type caches all client requests and application server response status indicators for active sessions on application servers that have a reliability index below the upper reliability threshold. Only the upper reliability threshold is set for the simple cache type. The variable cache type allocates a variable amount of cache for partially reliable application servers, based on the reliability index. An upper reliability threshold and lower reliability threshold is set for the variable cache type. When using a variable cache type, and application server with a reliability index below the lower reliability threshold will cache all client requests and application server reply status indicators for active sessions. A variable amount of cache is reserved for application servers with a reliability index between the lower reliability threshold and upper reliability threshold. No cache is used for application servers with a reliability index above the upper reliability threshold for either cache type.

Configuration component 400 reads the cache type and reliability thresholds and saves them to configuration file 350 (424). If the user selected a variable cache type (426), the user must also set the cache size limit for partially reliable application servers (428). Configuration component 400 reads the cache size limit and saves it to configuration file 350 (430). If the user wants to change commit point settings for streaming media sessions (432), configuration component 400 reads the setting change and saves it to configuration file 350 (434). If the user makes no more changes (436), configuration component 400 stops (438).

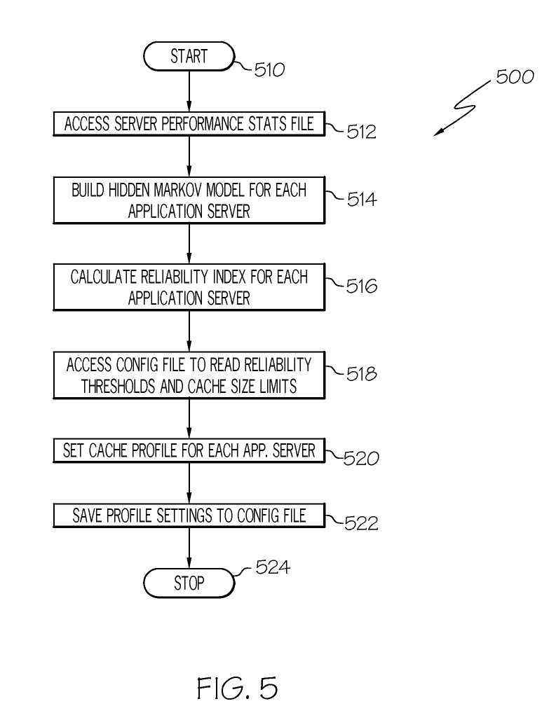

HMM Analyzer 500, as shown in FIG. 5, starts at regular intervals as designated in configuration file 350 (510). HMM Analyzer 500 accesses server performance statistics file 340 (512) and builds a Hidden Markov Model (HMM) on reliability for each application server (514). Server performance statistics file 340 is generated by autonomic manager 330 as a normal part of the monitoring, analysis and event logging functions of autonomic manager 330. A Hidden Markov Model is a statistical modeling method known in the art that observes known parameters to predict unknown parameters. HMM is unique in that the calculated probability of moving from a first state to a second state is independent of the history of transitions that led to the second state. In Intelligent Caching Tool 300, the HMM analysis predicts the probability that a server will have a failure based on factors such as number of requests, size of requests and exception messages. Further, HMM Analyzer 500 is adapted to accommodate predictive failures on a server based on known risk factors, such as identifying a server that is running hot or a server using a hard drive nearing its life expectancy. HMM Analyzer 500 calculates a reliability index for each application server based on the HMM analysis (516). HMM Analyzer 500 accessed configuration file 350 and reads the reliability thresholds and cache size limits for each application server (518). HMM Analyzer 500 sets a cache profile for each server using the reliability index, reliability threshold(s) and cache size limits (520). There are three possibilities for the cache profile for a given application server. If the server reliability index is above the upper reliability threshold, no cache is used. If the server reliability index is below the upper reliability threshold (or lower reliability threshold in the case of a variable cache type), the server can use as much cache as necessary to cache all client requests and application server response status indicators for all active sessions. If the server reliability index is between the upper reliability threshold and lower reliability threshold in the case of a variable cache type, then a variable amount of cache is allocated, based on the cache size limit and the reliability index. The cache allocation may be, for example, an inverse linear function of the application server reliability index not to exceed the cache size limit. HMM Analyzer 500 saves the cache profile for each application server to configuration file 350 (522) and stops (524).

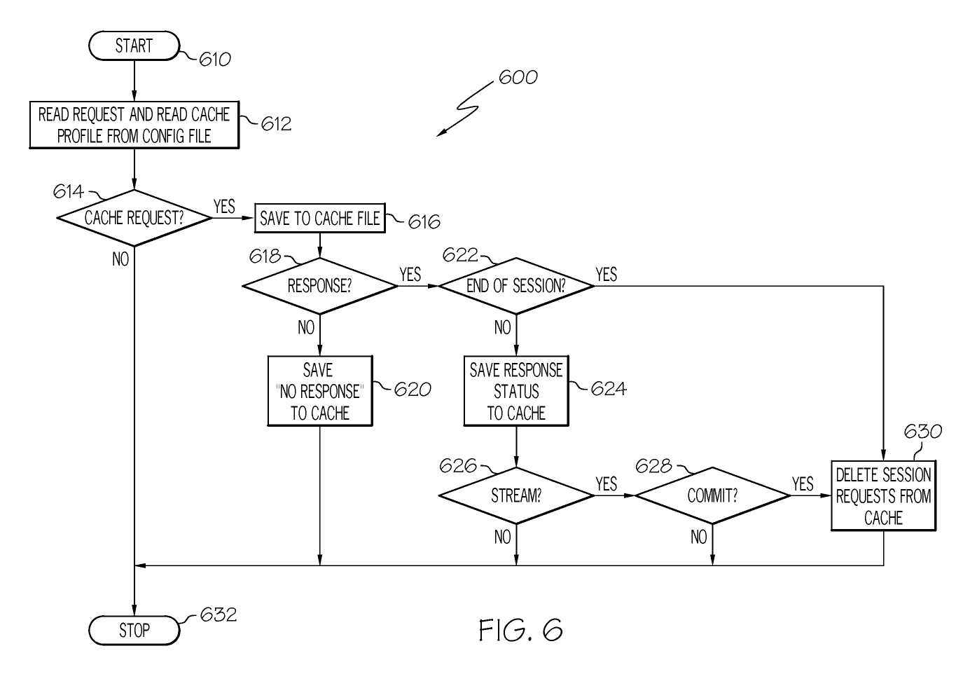

FIG. 6 shows request caching component 600 starting whenever a client request is received at web server 115 and forwarded to web application 370 running on one of application servers 120, 125 or 130 (610). Request caching component 600 reads the target application server from the client request and reads the cache profile from configuration file 350 (612). Request caching component 600 uses the cache profile to determine if the request needs to be cached (614). If the cache profile indicates that no cache is used for the target application server, request caching component 600 stops (632). If cache is used for the target server, the client request is saved to cache 360 (616). Request caching component 600 determines if the target application server responds to the client request (618). If the target application server does not respond, request caching component 600 saves a “no response” status indicator to cache 360 (620) and stops (632). If target server application responds, request caching component 600 determines if the response ends the client/server session (622). If the response ends the client/server session, request caching component 600 deletes all requests and response status indicators for the client/server session from cache 360 (630) and stops (632). If the response does not end the client/server session, request caching component 600 saves a response status indicator for the response in cache 360 (624). After saving the response status indicator, request caching component 600 determines if the response includes streaming media (626). If the response does not include streaming media, request caching component 600 stops (632). If the response includes streaming media, request caching component 600 determines if a commit point as defined in configuration file 350 has been reached (628). If a commit point has not been reached, request caching component 600 stops (632). If a commit point has been reached, request caching component 600 deletes all requests and response status indicators for the client/server session from cache 360 (630) and stops (632).

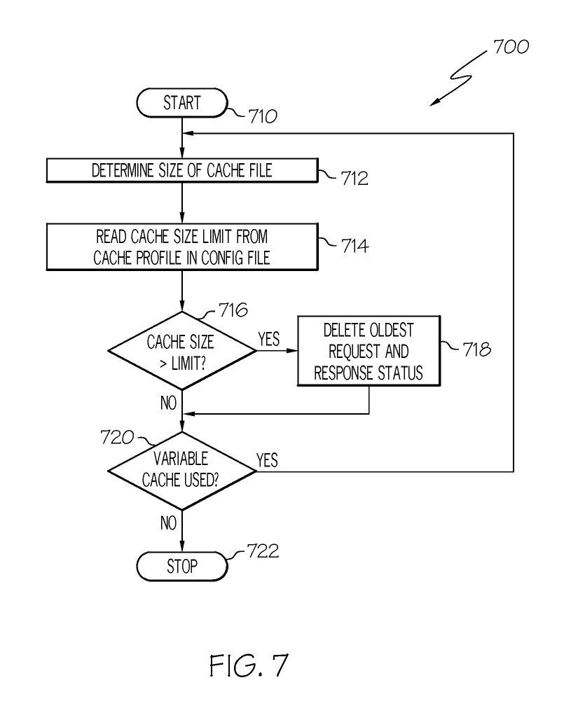

Cache monitoring component 700 starts whenever configuration component 400 designates use of variable cache, as shown in FIG. 7. Cache monitoring component 700 determines the current size of cache 360 (712) and reads the cache size limit from the cache profile in configuration file 350 (714). Cache monitoring component 700 compares the cache size to the cache limit (716). If the cache size exceeds the cache limit, cache monitoring component 700 deletes the oldest request and response status indicator from cache 360 (718). For as long as configuration file 350 indicates use of variable cache in the cache profile (720), Cache monitoring component 700 repeats steps 712-720. Whenever configuration file 350 stops indicating use of variable cache, cache monitoring component 700 stops (722).

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for caching client requests based on the predicted reliability of an application server, the computer implemented process comprising:
collecting reliability statistics for the application server;
building a Hidden Markov Model using the reliability statistics;
calculating a reliability index for the application server;
setting an upper reliability threshold; and
saving all client requests and the status of the application server's responses to a cache if the reliability index is below the upper reliability threshold.

2. The computer implemented process of claim 1 further comprising using the cache to fail-over client/server sessions if the application server has a failure.

3. The computer implemented process of claim 1 further comprising deleting the client requests and status of the application server's responses from the cache for a client/server session once the client/server session ends.

4. The computer implemented process of claim 1 further comprising identifying at least one commit point when the application server response includes streaming media and deleting the client requests and status of the application server's responses from the cache for a client/server session once the at least one commit point is reached.

5. The computer implemented process of claim 1 further comprising:
setting a lower reliability threshold; and
setting a cache size limit for the cache of application servers with a reliability index between the upper reliability threshold and the lower reliability threshold.

6. The computer implemented process of claim 5 further comprising deleting the oldest client request and the status of the application server's responses from the cache when the cache size exceeds the cache size limit.

7. The computer implemented process of claim 1 wherein the reliability index calculation includes predictive failures based on known risk factors.

8. An apparatus for caching client requests based on the predicted reliability of an application server, the apparatus comprising:
a processor;
a memory connected to the processor;
an application running in the memory accessible by a remote client;
an intelligent caching tool program in the memory operable to collect reliability statistics for the application server, build a Hidden Markov Model using the reliability statistics, calculate a reliability index for the application server, set an upper reliability threshold, and save all client requests and the status of the application server's responses to a cache if the reliability index is below the upper reliability threshold.

9. The apparatus of claim 8 wherein the intelligent caching tool program in the memory is further operable to use the cache to fail-over client/server sessions if the application server has a failure.

10. The apparatus of claim 8 wherein the intelligent caching tool program in the memory is further operable to delete the client requests and status of the application server's responses from the cache for a client/server session once the client/server session ends.

11. The apparatus of claim 8 wherein the intelligent caching tool program in the memory is further operable to identify at least one commit point when the application server response includes streaming media and delete the client requests and status of the application server's responses from the cache for a client/server session once the at least one commit point is reached.

12. The apparatus of claim 8 wherein the intelligent caching tool program in the memory is further operable to set a lower reliability threshold and set a cache size limit for the cache of application servers with a reliability index between the upper reliability threshold and the lower reliability threshold.

13. The apparatus of claim 12 wherein the intelligent caching tool program in the memory is further operable to delete the oldest client request and the status of the application server's responses from the cache when the cache's size exceeds the cache size limit.

14. A computer readable memory containing a plurality of executable instructions to cause a computer to cache client requests based on the predicted reliability of an application server, the plurality of instructions comprising:
a first instruction to collect reliability statistics for the application server;
a second instruction to build a Hidden Markov Model using the reliability statistics;
a third instruction to calculate a reliability index for the application server;
a fourth instruction to send setting an upper reliability threshold; and
a fifth instruction to save all client requests and the status of the application server's responses to a cache if the reliability index is below the upper reliability threshold.

15. The computer readable memory of claim 14 further comprising an instruction to using the cache to fail-over client/server sessions if the application server has a failure.

16. The computer readable memory of claim 14 further comprising an instruction to delete the client requests and status of the application server's responses from the cache for a client/server session once the client/server session ends.

17. The computer readable memory of claim 14 further comprising an instruction to identify at least one commit point when the application server response includes streaming media and delete the client requests and status of the application server's responses from the cache for a client/server session once the at least one commit point is reached.

18. The computer readable memory of claim 14 further comprising:
an instruction to set a lower reliability threshold; and
an additional instruction to set a cache size limit for the cache of application servers with a reliability index between the upper reliability threshold and the lower reliability threshold.

19. The computer readable memory of claim 18 further comprising an instruction to delete the oldest client request and the status of the application server's responses from the cache when the cache's size exceeds the cache size limit.

20. The computer readable memory of claim 14 wherein the third instruction to calculate a reliability index includes calculating predictive failures based on known risk factors.
